(19) United States
(12) Patent Application Publication
(10) Pub. No.: US 2009/0195337 A1
(43) Pub. Date: Aug. 6, 2009

(54) MANUALLY SELECTABLE INSTANTANEOUS CURRENT SETTINGS FOR A TRIP UNIT AND ELECTRICAL SWITCHING APPARATUS INCLUDING THE SAME

(76) Inventors: HARRY J. CARLINO, Export, PA (US); Todd M. Shaak, Presto, PA (US)

Correspondence Address: Martin J. Moran, 1000 Cherrington Parkway, Moon Township, PA, 15108, US

(21) Appl. No.: 12/023,595

(22) Filed: Jan. 31, 2008

(51) Int. Cl. H01H 73/00; H01H 83/06

(52) U.S. Cl. 335/18; 335/21

(57) ABSTRACT

A circuit breaker includes separable contacts, an operating mechanism structured to open and close the separable contacts, and a trip mechanism cooperating with the operating mechanism to trip open the contacts. The trip mechanism includes a current transformer structured to sense a current flowing through the contacts and provide a signal representative of the current. A manually operable selector selects one of a plurality of predetermined current conditions by using a plurality of different zener diodes. Each of the predetermined current conditions is greater than an arc reduction maintenance current condition of four times the maximum rated current of the trip mechanism. An instantaneous trip circuit cooperates with the current transformer and the manually operable selector to compare the signal representative of the current with respect to the selected one of the predetermined current conditions. The instantaneous trip circuit responsively causes the operating mechanism to instantaneously trip open the contacts.

### BACKGROUND OF THE INVENTION

1. Field of the Invention

This invention pertains generally to electrical switching apparatus and, more particularly, to electrical switching apparatus, such as circuit breakers, including a trip unit. The invention also relates to trip units for circuit interrupters.

2. Background Information

Electrical switching apparatus include, for example, circuit switching devices; circuit interrupters, such as circuit breakers; network protectors; contactors; motor starters; motor controllers; and other load controllers. Electrical switching apparatus such as circuit interrupters and, in particular, circuit breakers of the molded case variety, are well known in the art. See, for example, U.S. Pat. No. 5,341,191.

Circuit breakers are used to protect electrical circuitry from damage due to an overcurrent condition, such as an overload condition or a relatively high level short circuit or fault condition. Molded case circuit breakers typically include a pair of separable contacts per phase. The separable contacts may be operated either manually by way of a handle disposed on the outside of the case or automatically in response to an overcurrent condition. Typically, such circuit breakers include an operating mechanism, which is designed to rapidly open and close the separable contacts, and a trip unit, which senses overcurrent conditions in an automatic mode of operation. Upon sensing an overcurrent condition, the trip unit trips the operating mechanism to a trip state, which moves the separable contacts to their open position.

Industrial circuit breakers often use a circuit breaker frame, which houses a trip unit. See, for example, U.S. Pat. Nos. 5,910,760; and 6,144,271. The trip unit may be modular and may be replaced, in order to alter the electrical properties of the circuit breaker.

It is well known to employ trip units which utilize a microprocessor to detect various types of overcurrent trip conditions and provide various protection functions, such as, for example, a long delay trip, a short delay trip, an instantaneous trip, and/or a ground fault trip. The long delay trip function protects the load served by the protected electrical system from overloads and/or overcurrents. The short delay trip function can be used to coordinate tripping of downstream circuit breakers in a hierarchy of circuit breakers. The instantaneous trip function protects the electrical conductors to which the circuit breaker is connected from damaging overcurrent conditions, such as short circuits. As implied, the ground fault trip function protects the electrical system from faults to ground.

The earliest electronic trip unit circuit designs utilized discrete components such as transistors, resistors and capacitors.

More recently, designs, such as disclosed in U.S. Pat. Nos. 4,428,022; and 5,525,985, have included microprocessors, which provide improved performance and flexibility. These digital systems sample the current waveforms periodically to generate a digital representation of the current. The microprocessor uses the samples to execute algorithms, which implement one or more current protection curves.

Some known molded case circuit breakers (MCCBs) include a short delay time setting. The actual short delay trip time is intentionally delayed and has a minimum trip time of approximately 37 milliseconds resulting from the calculation time of a short delay algorithm performed by a microprocessor. The instantaneous feature of these MCCBs is provided by a fixed analog override circuit. A single zener diode is predetermined with a single fixed threshold value. The fixed analog override circuit detects a peak current value and initiates a trip in less than one line cycle. Because the zener diode is a fixed and non-adjustable component, the instantaneous trip threshold is set to a single fixed value.

For example, as shown in the trip curve of FIG. 1, the top vertical line near 1.15× is known as the Long Delay Pickup (LDP). Here, in this example, there is no trip for sensed currents below about 1.15 times the continuous current rating of the circuit breaker. The diagonal line between 1.15× and 6× is known as the Long Delay Time (LDT). This provides the trip time for sensed currents between about 1.15 and about 6 times the continuous current rating of the circuit breaker. The horizontal line at about 120 milliseconds is known as the Short Delay Time (SDT). This could also have settings of, for example and without limitation, about 50 and about 300 milliseconds. Actual short delay trip times corresponding to the 50, 120 and 300 millisecond settings are typically about 37, 87 and 275 milliseconds, respectively. Finally, the horizontal line at about 15 milliseconds is known as the Instantaneous Time. The trip unit will trip at this time if the sensed current is above about 12 times the maximum rated current (or sensor rating) of the circuit breaker trip unit. The continuous current rating may be the same as the maximum rated current (as shown in FIG. 1) or may be a percentage (<100%) (not shown) of the maximum rated current.

U.S. Pat. No. 7,203,040 discloses a circuit breaker and trip unit including an ARMS for reduction of arc flash energy and the severity of arc flash exposure. Specific trip functions are manually overridden with a maintenance trip function that reduces arc energy should a fault occur. In the ARMS mode, the maintenance trip function reduces the pickup currents and/or reduces or eliminates the time delays of the specified trip functions.

There is room for improvement in electrical switching apparatus, such as circuit interrupters.

There is also room for improvement in trip units for circuit interrupters.

### SUMMARY OF THE INVENTION

It is desirable in selective coordination schemes to have a manually selectable instantaneous trip threshold.

This need and others are met by embodiments of the invention, which provide a plurality of manually selectable predetermined current conditions, which are greater than an arc reduction maintenance current condition, for an instantaneous trip circuit of an electrical switching apparatus, such as, for example, a circuit interrupter. These predetermined current conditions range, for example, from about six to about twelve times the maximum rated current of the circuit interrupter trip mechanism.

In accordance with one aspect of the invention, an electrical switching apparatus comprises: separable contacts; an operating mechanism structured to open and close the separable contacts; and a trip mechanism cooperating with the operating mechanism to trip open the separable contacts, the trip mechanism comprising: a sensor structured to sense a current flowing through the separable contacts and provide a signal representative of the current, a manually operable selector structured to select one of a plurality of predetermined current conditions, each of the predetermined current conditions being greater than an arc reduction maintenance current condition, and an instantaneous trip circuit cooperating with the sensor and the manually operable selector to compare the signal representative of the current with respect to the selected one of the predetermined current conditions, and responsively cause the operating mechanism to instantaneously trip open the separable contacts.

The instantaneous trip circuit may comprise a trip coil and a comparator including a first input electrically interconnected with the sensor, a second input having a reference voltage and an output structured to cause the trip coil to be energized and cause the operating mechanism to trip open the separable contacts. The first input of the comparator may have a voltage with a magnitude, which is normally greater than the reference voltage. The sensor may be further structured to decrease the voltage of the first input of the comparator with increases in the current flowing in the electrical circuit. The manually operable selector may be further structured to decrease the voltage of the first input of the comparator upon selection of a smaller one of the predetermined current conditions.

As another aspect of the invention, a trip unit is for a circuit interrupter for an electrical circuit. The trip unit comprises: a sensor structured to sense a current flowing in the electrical circuit and provide a signal representative of the current; a manually operable selector structured to select one of a plurality of predetermined current conditions, each of the predetermined current conditions being greater than an arc reduction maintenance current condition; and an instantaneous trip circuit cooperating with the sensor and the manually operable selector to compare the signal representative of the current with respect to the selected one of the predetermined current conditions, and responsively instantaneously generate a trip signal.

The manually operable selector may comprise a plurality of zener diodes, each of the zener diodes having a corresponding different value. The instantaneous trip circuit may be an analog instantaneous trip circuit cooperating with one of the zener diodes, the one of the zener diodes corresponding to the selected one of the predetermined current conditions.

The predetermined current conditions may include a plurality of different current conditions between a first value and a larger second value. The manually operable selector may further comprise an open input corresponding to the larger second value. The manually operable selector may be structured to selectively cause none of the second zener diodes to be electrically connected in parallel with the first zener diode responsive to selection of one of the different current conditions having the larger second value.

### BRIEF DESCRIPTION OF THE DRAWINGS

A full understanding of the invention can be gained from the following description of the preferred embodiments when read in conjunction with the accompanying drawings in which:

FIG. 1 is a plot of a trip curve for a trip unit including current versus time.

FIG. 2 is an isometric view of a circuit breaker including a trip unit in accordance with embodiments of the invention.

FIG. 3 is a schematic diagram in block form of the circuit breaker of FIG. 2 shown connected to an electrical system.

FIG. 4 is a top plan view of the trip unit of FIG. 2.

FIG. 5 is an isometric view of the faceplate assembly of the trip unit of FIG. 2.

FIG. 6 is a plan view of the legend of the faceplate of FIG. 2.

FIGS. 7-9 are plots of trip curves for the trip unit of FIG. 2 including current versus time.

FIG. 10 is a block diagram in schematic form of the selector switch printed circuit board of FIG. 5.

FIGS. 11 and 12 are block diagrams in schematic form of instantaneous trip circuits in accordance with other embodiments of the invention.

### DESCRIPTION OF THE PREFERRED EMBODIMENTS

As employed herein, the term “number” shall mean one or an integer greater than one (i.e., a plurality).

As employed herein, the term “processor” means a programmable analog and/or digital device that can store, retrieve, and process data; a computer; a workstation; a personal computer; a microprocessor; a microcontroller; a microcomputer; a central processing unit; a mainframe computer; a mini-computer; a server; a networked processor; or any suitable processing device or apparatus.

As employed herein, the statement that two or more parts are “connected” or “coupled” together shall mean that the parts are joined together either directly or joined through one or more intermediate parts. Further, as employed herein, the statement that two or more parts are “attached” shall mean that the parts are joined together directly.

As employed herein, the term “selector switch” means a manually operable rotary selector switch, a manually operable and pivotally coupled selector switch, or any suitable manually operable selection apparatus structured to select one current condition from a plurality of different current conditions.

As employed herein, the term “total trip delay” means the sum of the operating delays which are inherent to the separable contacts, the operating mechanism, the instantaneous trip circuit and the sensor of an electrical switching apparatus, plus any intentional delay, if any, above those inherent operating delays. For example, the separable contacts and the operating mechanism are typically mechanical structures, which require relatively small operating times to trip open the separable contacts. Also, the instantaneous trip circuit and the sensor are typically electrical structures, which require relatively very small operating times to sense the current flowing through the separable contacts, determine if that sensed current exceeds a predetermined trip threshold, and cause the operating mechanism to trip open the separable contacts.

As employed herein, the term “instantaneous trip circuit” expressly excludes a short delay trip circuit, a long delay trip circuit, a ground fault trip circuit, an arc fault trip circuit and/or a trip circuit providing a total trip delay for an electrical switching apparatus of greater than 33.333 ms (e.g., two line cycles at 60 Hz).

As employed herein, the terms “instantaneous” or “instantaneously” mean: (1) without any intentional trip delay other than the operating delays for a trip operation, which operating delays are inherent to the separable contacts, the operating mechanism, the instantaneous trip circuit and/or the sensor of an electrical switching apparatus, and/or (2) a total trip delay (e.g., about 8 ms; about 15 ms; about 16.666 ms; about 20 ms; any suitable time of about one line cycle or less), which is less than or equal to about one line cycle at about 50 Hz or about 60 Hz.

As employed herein, the term “one-cycle instantaneous” means a total trip delay (e.g., about 8 ms; about 15 ms; about 16.666 ms; about 20 ms; any suitable time of about one line cycle or less), which is less than or equal to about one line cycle at about 50 Hz or about 60 Hz.

As employed herein, the term “two-cycle instantaneous” means a total trip delay, which is less than 33.333 ms (e.g., two line cycles at 60 Hz).

As employed herein, the term “arc reduction maintenance current condition” means a current condition of four times the maximum rated current of an electrical switching apparatus trip mechanism.

As employed herein, the term “maximum rated current” means the same as the maximum rated current value or sensor rating of the number of current sensors (e.g., without limitation, current transformers) of a trip mechanism (e.g., without limitation, trip unit) of an electrical switching apparatus (e.g., without limitation, circuit breaker).

As employed herein, the term “continuous current rating” means the same as the rated current of a trip mechanism (e.g., without limitation, trip unit) of an electrical switching apparatus (e.g., without limitation, circuit breaker). The continuous current rating may be the same as or less than the maximum rated current of such trip mechanism.

The invention is described in association with a three-phase circuit breaker, although the invention is applicable to electrical switching apparatus having any number of phases or poles, and to trip units for such electrical switching apparatus.

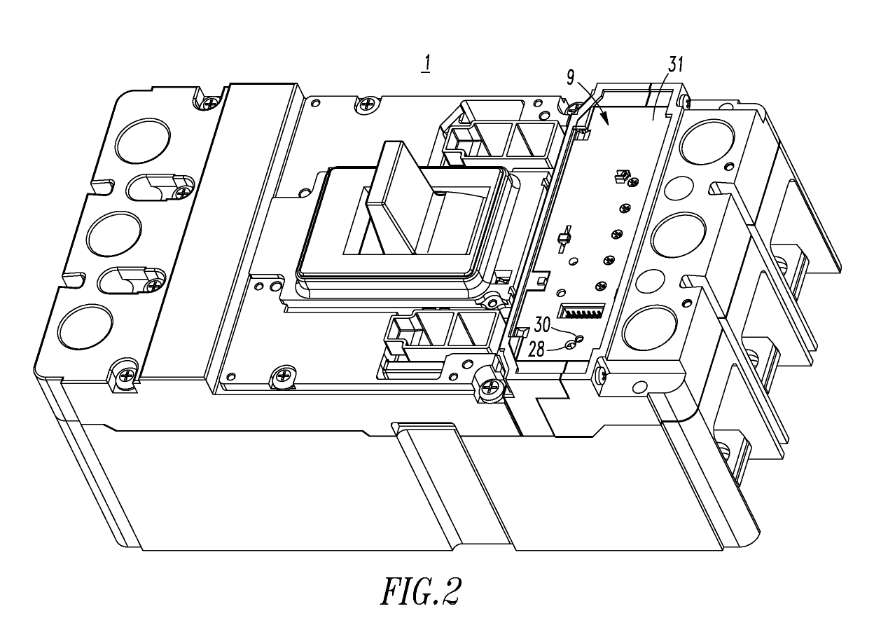

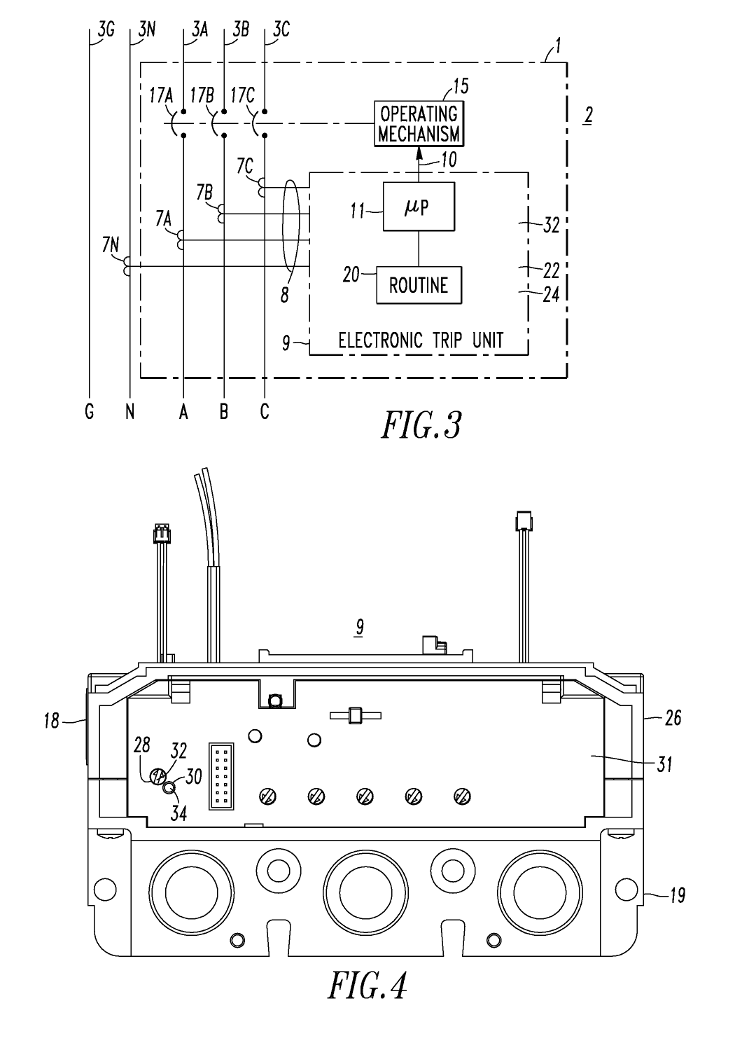

FIG. 2 shows an electrical switching apparatus, such as a circuit interrupter as is shown by the example circuit breaker 1. Referring to FIG. 3, this circuit breaker 1 protects an example electrical circuit, such as electrical system 2, which includes three phase (e.g., A, B and C) electrical circuit conductors 3A, 3B and 3C, and which may also include a neutral (N) conductor 3N and a ground (G) conductor 3G. The example circuit breaker is a microprocessor-based circuit breaker 1. The circuit breaker 1 includes sensors, such as current transformers (CTs) 7A, 7B, 7C, and 7N, which generate signals 8 representative of the currents flowing in the respective phase conductors 3A, 3B and 3C, and in the neutral conductor 3N if desired.

A trip mechanism, such as a trip circuit as shown by the example electronic trip unit 9, monitors the currents sensed by these CTs 7A,7B,7C,7N and generates a trip signal 10 in response to predetermined current and/or predetermined current/time conditions. The electronic trip unit 9 incorporates a suitable processor, such as the example microprocessor (μP) 11. In the example embodiment, the CTs 7A,7B,7C,7N of the electronic trip unit 9 determine the maximum rated current of the trip unit 9.

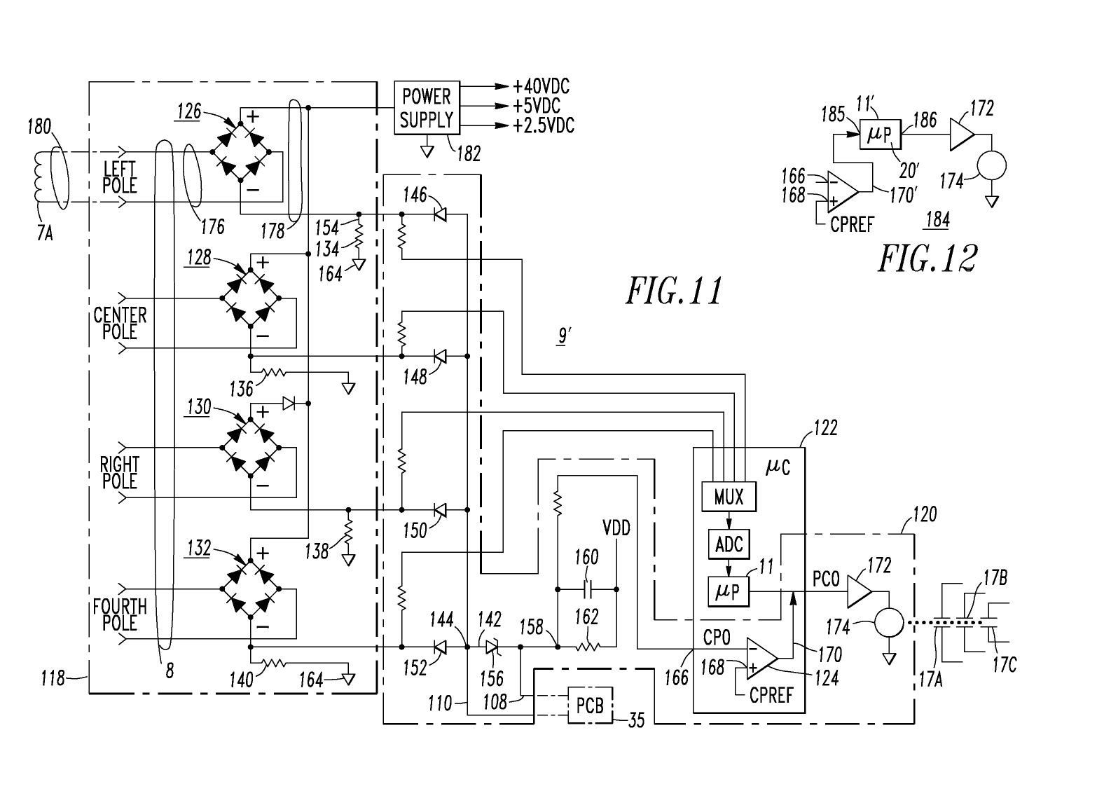

The electronic trip unit 9 generates the trip signal 10 in response to the specified overcurrent conditions. As is conventional, an operating mechanism 15 is structured to open and close sets of separable contacts 17A, 17B and 17C. The trip signal 10 actuates (through a suitable trip device (e.g., without limitation, trip coil (174 of FIG. 11); trip solenoid (not shown)) the operating mechanism 15, which responsively opens the sets of separable contacts 17A, 17B and 17C, in order to interrupt current through the corresponding phase conductors 3A, 3B and 3C of the electrical system 2. Hence, the trip unit 9 cooperates with the operating mechanism 15 to trip open the separable contacts 17A,17B,17C.

The circuit breaker 1 and, in particular, the electronic trip unit 9, provide several modes of protection. In particular, an instantaneous protection mode and an Arc Reduction Maintenance System (ARMS) protection mode are provided.

Long delay, short delay and/or ground fault protection, and/or other suitable protection modes, may also be provided. The trip unit 9 preferably includes a routine 20 executed by the μP 11.

As will be discussed below in connection with FIGS. 3-5, a manually operable selector 32 is structured to select one of a plurality of predetermined current conditions, each of the predetermined current conditions being greater than the arc reduction maintenance current condition of four times the maximum rated current of the trip unit 9. In the instantaneous protection mode, the trip unit 9 is structured to compare the signals 8 with respect to a selected one of a plurality of predetermined current conditions 22 and responsively instantaneously generate the trip signal 10. There are also a separate number of predetermined ARMS current conditions 24, as will be discussed.

As best shown in FIG. 4, the trip unit 9 includes a housing 26 having a first opening 28 and a second opening 30. A manually operable selector, such as selector switch 32, is disposed proximate the first opening 28 and is structured to select one of the predetermined current conditions 22 and the number of predetermined ARMS current conditions 24 of FIG. 3.

An example movable indicator 34 cooperates with the selector switch 32 and is disposed proximate the second opening 30. The movable indicator 34 is structured to indicate whether one of the predetermined current conditions 22 or one of the number of predetermined ARMS current conditions 24 is selected by the selector switch 32. The example trip unit 9 (FIGS. 3 and 4) employs the movable indicator 34 and, for example, has insufficient power (or no power under certain conditions) for an LED or other lit status non-movable indicator. Alternatively, either an electronic indicator or no indicator can be employed.

Referring to FIGS. 4 and 5, the trip unit housing 26 (FIG. 4) includes a faceplate 31 having the first opening 28 and the second opening 30 (FIG. 4). The trip unit 9 includes a printed circuit board (PCB) 35 coupled to the faceplate 31 by standoffs, such as molded offsets 36,37, and fasteners 38,39. For example, coupling the PCB 35 to the faceplate 31 with the molded offsets 36,37 of the faceplate 31 (e.g., without limitation, a thermoplastic component) reduces the count of molded components by eliminating the need to change molds (not shown) for the base 18 and the cover 19 (e.g., without limitation, thermoset components) of the trip unit 9 (FIG. 4).

The selector switch 32 is pivotally coupled to the PCB 35. The movable indicator 34 is peripherally coupled to the selector switch 32 and is structured to pivot with the selector switch 32. In particular, the selector switch 32 is a rotary selector switch including a pivot member 40 pivotally disposed with respect to the trip unit housing 26 and a selector member 42 coupled to the pivot member 40. The selector member 42 is disposed at the first housing opening 28. The movable indicator 34 includes a peripheral member 44 peripherally disposed about the selector member 42 and movable therewith. The peripheral member 44 is disposed at the second housing opening 30 (FIG. 4). The pivot member 40 includes an opening (not shown) that receives a pivot post (not shown) that is coupled to the PCB 35. The movable indicator 34 also includes an indicator member (not shown) coupled to the peripheral member 44 and disposed at the second housing opening 30.

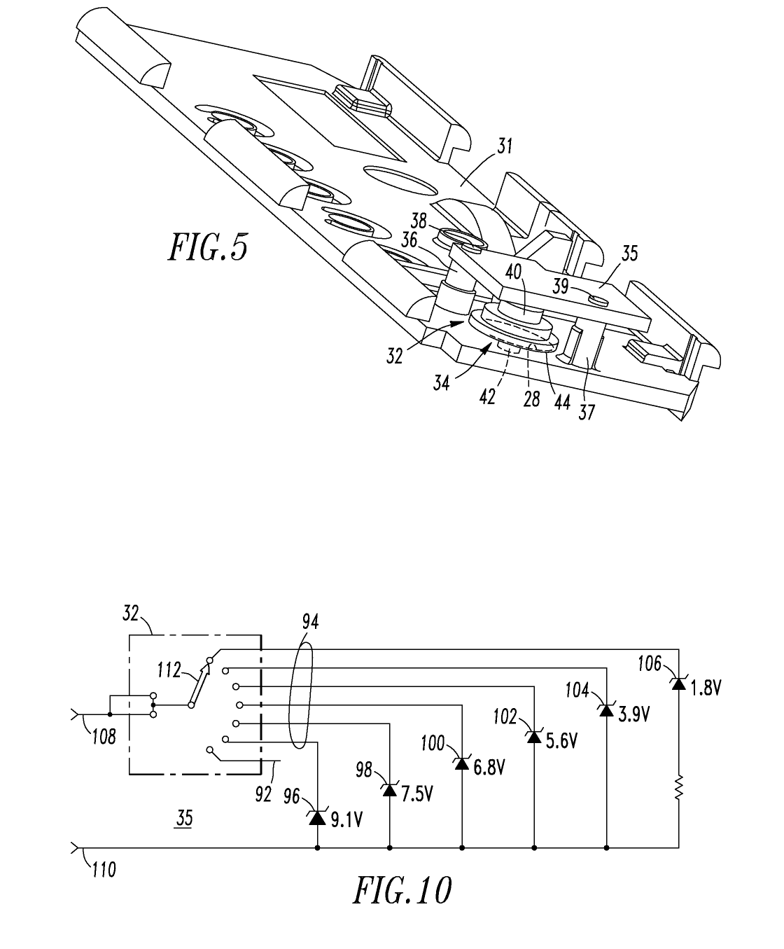

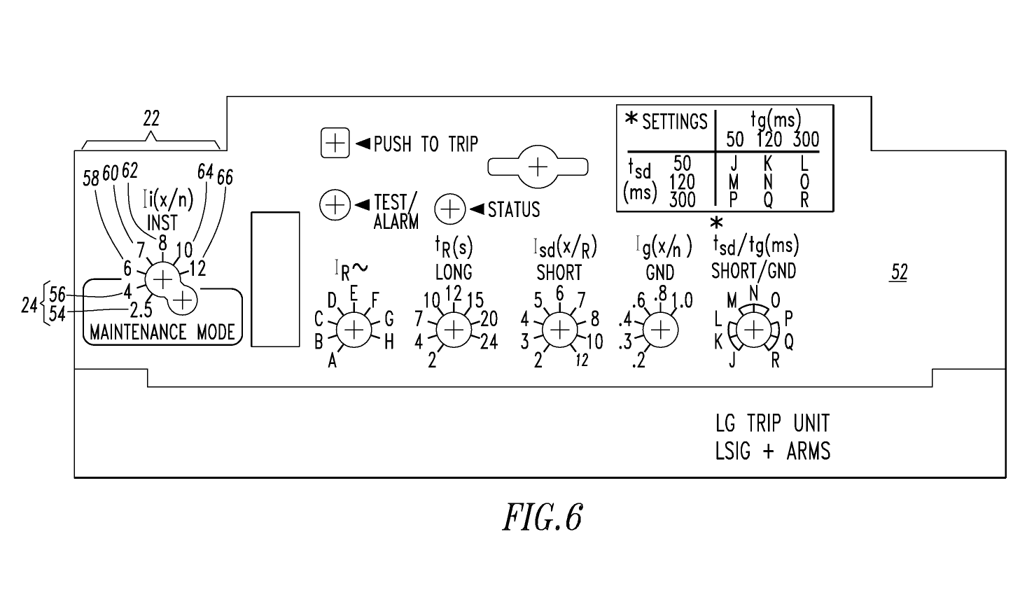

FIG. 6 shows an example legend 52 of the faceplate 31 of FIG. 2. In this example, the circuit breaker trip unit 9 includes a maximum rated current. The example number of predetermined ARMS current conditions 24 include a first current condition 54 of about two and one-half times the maximum rated current and a second current condition 56 of about four times the maximum rated current. The example predetermined current conditions 22 include the different current conditions 58,60,62,64,66 between about six times the maximum rated current at condition 58 and about twelve times the maximum rated current at condition 66. All of the different instantaneous current conditions 58,60,62,64,66 are greater than all of the different ARMS current conditions 54,56. The conditions 60, 62 and 64 correspond to seven, eight and ten times, respectively, the maximum rated current.

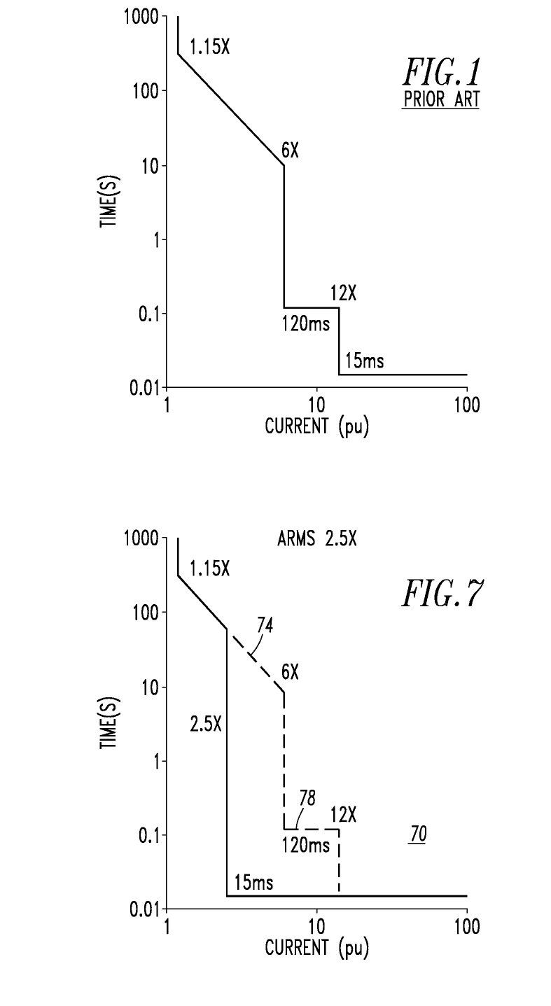

FIGS. 7 and 8 show trip curves 70,72 similar to that of FIG. 1, except that portions 74,76 of the Long Delay Time and the entire Short Delay Time 78 are overridden above 2.5 times (FIG. 7) or four times (FIG. 8) the maximum rated current.

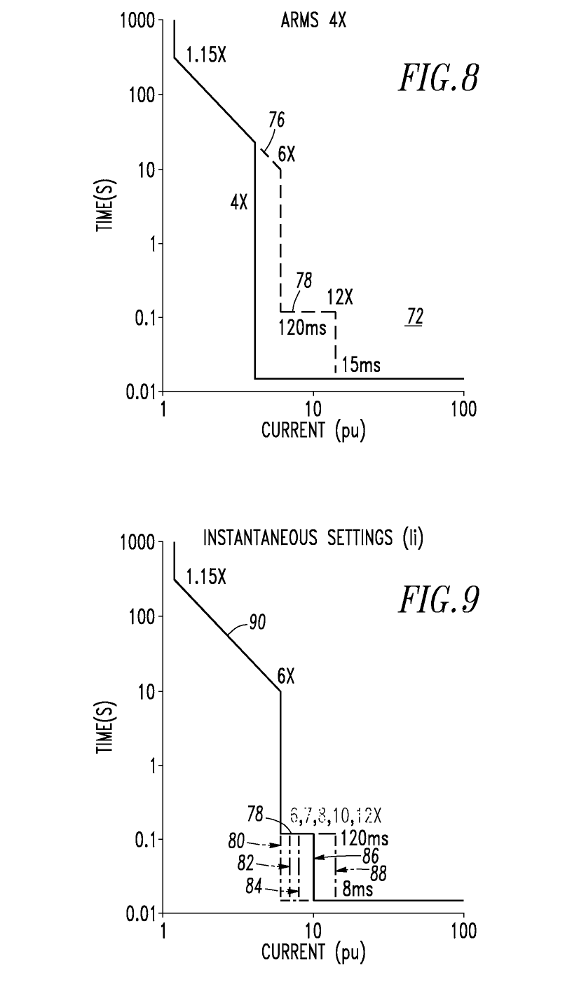

FIG. 9 shows trip curves 80,82,84,86,88 (86 is shown in solid line drawing, while 80,82,84,88 are shown in phantom line drawing) similar to the trip curves 70,72 of FIGS. 7 and 8, except that none of the Long Delay Time 90 is overridden and none, some or all of the Short Delay Time 78 is overridden above 6, 7, 8, 10 or 12 times the maximum rated current. In the example embodiment, the trip curves 80,82,84,86,88 include a common trip time corresponding to the predetermined current conditions 22 (FIG. 6) of about 8 milliseconds, although any suitable total trip delay (e.g., one-cycle instantaneous; two-cycle instantaneous) may be employed by the instantaneous trip circuit (e.g., 120 of FIG. 11).

The μP 11 and, in particular, the routine 20 of FIG. 3 are structured to provide a substantial portion of the trip curves 80,82,84,86,88, which typically correspond to the maximum of the signals 8 representative of currents flowing through the separable contacts 17A, 17B, 17C, for such currents of less than about six times the maximum rated current. As will be discussed, below, in connection with FIGS. 10 and 11, an instantaneous trip circuit 120 and the PCB 35 advantageously override those trip curves 80,82,84,86,88 for a selected one of five example currents between about six and about twelve times the maximum rated current.

Referring to FIG. 10, the selector switch PCB 35 of FIG. 5 is shown. The example seven-position selector switch 32 includes one input 92 that corresponds to an open circuit, and six inputs 94 that receive the cathodes of six different zener diodes 96,98,100,102,104,106. Although example different zener voltages ranging from 9.1 V to 1.8 V are shown with the six different zener diodes 96,98,100,102,104,106, it will be appreciated that any suitable different zener voltages may be employed. The PCB 35 includes two outputs 108,110, which are respectively electrically connected to a movable arm 112 of the selector member 42 of FIG. 5 and to the anodes of the different zener diodes 96,98,100,102,104,106.

Referring to FIG. 11, another trip unit 9′, which may be the same as or similar to the trip unit 9 of FIG. 3, is shown. The trip unit 9′ includes a sensor circuit 118, an instantaneous trip circuit 120, and a microcomputer (μC) 122, which includes the μP 11 of FIG. 3. As shown, a portion of the μC 122 in the form of a comparator 124 may be used by the instantaneous trip circuit 120, although a separate and independent comparator (not shown) may alternatively be employed. The instantaneous trip circuit 120 advantageously interfaces with the PCB 35 of FIG. 10.

The sensor circuit 118 includes four full-wave bridges 126,128,130,132 usable with the CTs 7A,7B,7C,7N of FIG. 3 for four circuit interrupter poles (e.g., corresponding to phases A,B,C and neutral). The full-wave bridges 126,128,130,132 are operatively associated with four burden resistors 134,136,138,140, respectively. A DC voltage 142 is derived from a common node 144, which is electrically interconnected to the burden resistors 134,136,138,140 by diodes 146,148,150,152, respectively. The DC voltage for a pole, such as voltage 154 across burden resistor 134, is negative and consists of the current through the corresponding burden resistor times the resistance of that burden resistor. The highest (most negative) peak voltage of the four burden resistors 134,136,138,140 can cause the zener breakdown of the zener diode 156. When the zener diode 156 breaks over, it tends to pull the node 158 common to capacitor 160 and resistor 162 toward ground 164.

The input (CP0) 166 is the external input (−) to the comparator 124 of μC 122. The other comparator input (+) (CPREF) 168 is internally referenced to +1.25 volts. When the voltage at the node 158 decreases below +1.25 volts, the comparator output (PC0) 170 goes high to provide the trip signal 10 (FIG. 3), which causes the separable contacts 17A,17B,17C to open.

As can be seen with reference to FIGS. 10 and 11, from the selector switch PCB 35 of FIG. 10, depending upon the position of the movable arm 112 of the selector member 42 of FIG. 5 for the predetermined current conditions 58,60,62,64 of FIG. 6, one of the different zener diodes 102,100,98,96, respectively, is electrically connected in parallel with the zener diode 156, which has an example zener voltage of 11 V, which corresponds to the predetermined current condition 66 of FIG. 6. The open circuit from input 92 is paralleled across zener diode 156 for the predetermined current condition 66. In turn, the lowest zener voltage level determines the instantaneous trip level. The desired one of the zener diodes 102,100,98,96 is switched in and out through the selector switch 32. The other zener diodes 104 and 106 are for the number of example ARMS current conditions 24 of FIG. 6.

In summary, the example analog instantaneous trip circuit 120 cooperates with the sensor circuit 118 and a manually operable selector, such as the example selector switch 32, to compare the voltage 142 representative of the highest phase current with respect to the selected one of the predetermined current conditions 22. When the comparator 124 determines that the voltage at the node 158 is below the voltage of the reference input 168, this causes the comparator output (PC0) 170 to go high. In turn, a buffer 172 energizes a trip coil 174, which causes the operating mechanism 15 (FIG. 3) to instantaneously trip open the separable contacts 17A,17B,17C.

The input (−) 166 of the comparator 124 has a voltage with a magnitude, which is normally greater than the voltage at the other comparator input (+) 168. The sensor circuit 118 is structured to decrease the voltage of the input 166 with increases in the current flowing in the electrical circuit 2 of FIG. 3. Also, the selector switch 32 (FIG. 10) is structured to decrease (increase) the voltage of the input 166 upon selection of a relatively smaller (larger) one of the zener voltages and, thus, a relatively smaller (larger) one of the predetermined current conditions 22.

As shown with the full wave bridge 126, each of the bridges 126,128,130,132 includes an input 176 and an output 178. The bridge input 176 receives the output 180 of the corresponding CT 7A. The bridge output 178 is used to power a power supply 182 and to provide the voltage 154 that is the signal representative of the current through the separable contacts 17A (FIG. 3). One end of the bridge output 178 is electrically connected to one end of the burden resistor 134. The other end of the burden resistor 134 is electrically connected to ground 164. It will be appreciated that the instantaneous trip circuit 120 of FIG. 11 can be applied to any number of circuit breaker poles.

In the example of FIG. 11, the μP 11 can separately and independently drive the output (PC0) 170 to the trip coil buffer 172. Alternatively, as shown in FIG. 12, an instantaneous trip circuit 184 includes a μP 11′ having an input 185 and an output 186. The μP input 185 receives the comparator output 170′, and the μP output 186 drives the trip coil buffer 172. This embodiment adds some time to the total trip delay relative to the instantaneous trip circuit 120 of FIG. 11, since the μP 11′ must sense the input 185 being active and, then, set the output 186. The μP 11′ includes a suitable routine 20′, which performs this function and the function(s) of the routine 20 of FIG. 3.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. An electrical switching apparatus comprising:
separable contacts;
an operating mechanism structured to open and close said separable contacts; and
a trip mechanism cooperating with said operating mechanism to trip open said separable contacts, said trip mechanism comprising:
a sensor structured to sense a current flowing through said separable contacts and provide a signal representative of said current,
a manually operable selector structured to select one of a plurality of predetermined current conditions, each of said predetermined current conditions being greater than an arc reduction maintenance current condition, and
an instantaneous trip circuit cooperating with said sensor and said manually operable selector to compare said signal representative of said current with respect to the selected one of said predetermined current conditions, and responsively cause said operating mechanism to instantaneously trip open said separable contacts.

2. The electrical switching apparatus of claim 1 wherein said instantaneous trip circuit comprises a trip coil and a comparator including a first input electrically interconnected with said sensor, a second input having a reference voltage and an output structured to cause said trip coil to be energized and cause said operating mechanism to trip open said separable contacts; wherein the first input of said comparator has a voltage with a magnitude, which is normally greater than said reference voltage; wherein the sensor is further structured to decrease the voltage of the first input of said comparator with increases in the current flowing in said electrical circuit; and wherein said manually operable selector is further structured to decrease the voltage of the first input of said comparator upon selection of a smaller one of said predetermined current conditions.

3. The electrical switching apparatus of claim 1 wherein said trip mechanism includes a maximum rated current; and wherein said predetermined current conditions include a plurality of different current conditions between about six times said maximum rated current and about twelve times said maximum rated current.

4. The electrical switching apparatus of claim 3 wherein said predetermined current conditions are selected from the group consisting of six, seven, eight, ten and twelve times said maximum rated current.

5. The electrical switching apparatus of claim 1 wherein said manually operable selector comprises a plurality of zener diodes, each of said zener diodes having a corresponding different value; and wherein said instantaneous trip circuit is an analog instantaneous trip circuit cooperating with one of said zener diodes, said one of said zener diodes corresponding to the selected one of said predetermined current conditions.

6. The electrical switching apparatus of claim 1 wherein said trip unit further comprises a processor structured to provide a trip curve corresponding to said signal representative of said current and time; wherein said trip curve includes a number of a long delay pickup, a long delay time and a short delay time; and wherein each of said long delay pickup, said long delay time and said short delay time corresponds to a number of current values, each of said number of current values being less than each of said predetermined current conditions.

7. The electrical switching apparatus of claim 6 wherein said trip curve includes a common time corresponding to a plurality of said predetermined current conditions.

8. The electrical switching apparatus of claim 7 wherein said common time is about 8 milliseconds.

10. The electrical switching apparatus of claim 1 wherein said instantaneous trip circuit comprises a comparator circuit and a first zener diode electrically interconnected between said sensor and said comparator circuit, said first zener diode having a first value corresponding to one of said predetermined current conditions; and wherein said manually operable selector comprises a plurality of second zener diodes, each of said second zener diodes having a corresponding second value which is less than the first value of said first zener diode, said corresponding second value corresponding to a different one of said predetermined current conditions.

11. The electrical switching apparatus of claim 1 wherein said instantaneous trip circuit comprises a trip coil and a comparator including a first input electrically interconnected with said sensor, a second input having a reference voltage and an output structured to cause said trip coil to be energized and cause said operating mechanism to trip open said separable contacts.

12. The electrical switching apparatus of claim 11 wherein said instantaneous trip circuit further comprises a processor including an input and an output, the input of said processor being structured to receive the output of said comparator, the output of said processor being structured to cause said trip coil to be energized responsive to the input of said processor and cause said operating mechanism to trip open said separable contacts.

13. A trip unit for a circuit interrupter for an electrical circuit, said trip unit comprising:
a sensor structured to sense a current flowing in said electrical circuit and provide a signal representative of said current;
a manually operable selector structured to select one of a plurality of predetermined current conditions, each of said predetermined current conditions being greater than an arc reduction maintenance current condition; and
an instantaneous trip circuit cooperating with said sensor and said manually operable selector to compare said signal representative of said current with respect to the selected one of said predetermined current conditions, and responsively instantaneously generate a trip signal.

14. The trip unit of claim 13 wherein said trip unit includes a maximum rated current; and wherein said predetermined current conditions include a plurality of different current conditions between about six times said maximum rated current and about twelve times said maximum rated current.

15. The trip unit of claim 13 wherein said manually operable selector comprises a plurality of zener diodes, each of said zener diodes having a corresponding different value; and wherein said instantaneous trip circuit is an analog instantaneous trip circuit cooperating with one of said zener diodes, said one of said zener diodes corresponding to the selected one of said predetermined current conditions.

16. The trip unit of claim 13 wherein said sensor comprises a current transformer structured to sense the current flowing in said electrical circuit, a burden resistor, and a full wave bridge including an input and an output, said current transformer including an output, the input of said full wave bridge receiving the output of said current transformer, the output of said full wave bridge being said signal representative of said current and being electrically connected to said burden resistor.

17. The trip unit of claim 13 wherein said instantaneous trip circuit comprises a comparator circuit and a first zener diode electrically interconnected between said sensor and said comparator circuit, said first zener diode having a first value corresponding to one of said predetermined current conditions; and wherein said manually operable selector comprises a plurality of second zener diodes, each of said second zener diodes having a corresponding second value which is less than the first value of said first zener diode, said corresponding second value corresponding to a different one of said predetermined current conditions.

18. The trip unit of claim 17 wherein said manually operable selector is structured to selectively cause one of said second zener diodes to be electrically connected in parallel with said first zener diode.

19. The trip unit of claim 18 wherein said predetermined current conditions include a plurality of different current conditions between a first value and a larger second value; wherein said manually operable selector further comprises an open input corresponding to said larger second value; and wherein said manually operable selector is structured to selectively cause none of said second zener diodes to be electrically connected in parallel with said first zener diode responsive to selection of one of said different current conditions having the larger second value.

20. The trip unit of claim 13 wherein said instantaneous trip circuit comprises a trip coil and a comparator including a first input electrically interconnected with said sensor, a second input having a reference voltage and an output structured to cause said trip coil to be energized and cause said operating mechanism to trip open said separable contacts; wherein the first input of said comparator has a voltage with a magnitude, which is normally greater than said reference voltage; wherein the sensor is further structured to decrease the voltage of the first input of said comparator with increases in the current flowing in said electrical circuit; and wherein said manually operable selector is further structured to decrease the voltage of the first input of said comparator upon selection of a smaller one of said predetermined current conditions.
